(19) United States
(12) Patent Application Publication
(10) Pub. No.: US 2013/0045309 A1
(43) Pub. Date: Feb. 21, 2013

(54) HONEY-CONTAINING PRODUCTS

(71) Applicant: Neophytos L. Papaneophytou, Hoboken, NJ (US)

(72) Inventor: Neophytos L. Papaneophytou, Hoboken, NJ (US)

(21) Appl. No.: 13/587,367

(22) Filed: Aug. 16, 2012

Related U.S. Application Data
(60) Provisional application No. 61/524,480, filed on Aug. 17, 2011.

(51) Int. Cl. A23L 1/08; A23P 1/10; A23G 1/50; A23L 1/221

(52) U.S. Cl. 426/93; 426/103; 426/573; 426/658; 426/576; 426/297

(57) ABSTRACT

A method of making a flavoring unit according to claim 1 which comprises forming a liquid composition containing honey and a molten edible gel-forming polymer, cooling said mixture to produce a gel and producing forming individual flavoring units containing from about 1 to about 20 grams of honey thereform. Preferably the unit comprises from 70 to 90% by weight honey incorporated in a gel which comprises honey and gelatin.

### FIELD OF THE INVENTION

The present invention relates to a product and method that can be used for sweetening beverages. This application claims priority from U.S. Provisional Application No. 61/524,480, the contents of which are herein incorporated by reference.

### BACKGROUND OF THE INVENTION

Honey has long been used to sweeten beverages since ancient times. Accounts of Roman drinking of honey-sweetened wine, known as mulsum, date back as early as the first century AD. However, the act of adding honey to a drink can be messy as a result of its high viscosity. Adding honey by use of a honeycomb provides one way to deal with this but requires breaking the honeycomb into suitably sized pieces, which can also be messy, and can result in large quantities of the waxy material of the honeycomb being incorporated into the drink.

The U.S. National Honey Board has suggested dehydrating honey for use as a sweetener.

Honey has also been combined with other edible materials for other purposes, for example it has been combined with gelatin in various types of dessert.

### SUMMARY OF THE INVENTION

The present invention provides discrete honey-containing flavoring units such as capsules or pats that can be added to drinks to sweeten them.

When such flavoring units are in the form of capsules, a measure of honey is surrounded by a coating that will dissolve in, melt in or otherwise be caused to rupture when added to a beverage that is to be sweetened. If contained in a pat, the honey will be contained in a matrix or gel of edible material that will melt or dissolve in the liquid that is to be sweetened. When the sweetener composition is in the form of a capsule, different types of casing may be appropriates depending on whether the beverage that it is intended to sweeten is normally consumed hot or cold. Similarly when a gel or matrix is used the nature of the supporting material may differ depending on the intended temperature of use.

### DETAILED DESCRIPTION OF THE INVENTION

Typically honey-containing units will contain from 0.1 to 3 teaspoons of honey (about from 1-20 grams), for example 0.2-2 teaspoons of honey (about 2-15 grams) or about 0.5 to 1 teaspoons (about 3-7 grams).

Honey can be incorporated into the products of the present invention in a number of different ways. In one embodiment, honey may be formed into a gel for example with an edible material melting in the 40-80° C. temperature range such as gelatin, carrageenans (such as kappa carageenan), pectins, alginates, other hydroxy colloids and combinations thereof. Other materials into which honey may be incorporated to form an edible polymer matrix include pullulan, hydroxypropylmethyl cellulose, hydroxyethyl cellulose, hydroxypropyl cellulose, polyvinyl pyrrolidone, carboxymethyl cellulose, polyvinyl alcohol, sodium aginate, polyethylene glycol, xanthan gum, tragancanth gum, guar gum, acacia gum, arabic gum, polyacrylic acid, methylmethacrylate copolymer, carboxyvinyl copolymers, starch, gelatin, and combinations thereof.

Typically flavoring units of this type where honey is incorporated into an edible polymer matrix will contain from 70-90% by weight honey. We have found that use of honey in a ranger 75%-85%, most suitably about 80% by weight honey is particularly useful. Some variation of the amounts may however, be possible depending on the type of honey used.

Typically, honey and the edible polymer such as gelatin will be mixed at a temperature in the range about 95 to about 150° F., preferably about 130 to about 150° F. The relative amounts of polymer such as gelatin will lie in the range about 1% to about 8% by weight, preferably about 2% about 5% by weight of the composition, the balance normally being water. The liquid mixture is then cooled to produce discrete flavor units containing from 1 to 20 grams of honey. This can be accomplished by pouring into molds of an appropriate size or more efficiently by cooling the mixture into a solid honey-containing mass and then dividing into flavor unit sized portions by cutting into the desired size.

When the flavoring units are in the form of capsules, suitable materials for forming a casing of a capsule that is to sweeten a hot beverage such as tea or coffee include fats such as palm oil and waxes such as food grade paraffin waxes as defined in 21 CFR 172.886, bees wax, rice bran wax, palm wax, carnuba wax and soybean wax which melt at the temperature of hot tea or coffee such as between about 38° C. and about 71° C. (between about 100 and about 160° F.) preferably between about 49° C. and about 66° C. (about 120 and about 150° F.). Other suitable casings include water soluble edible poltmers, and water degradable starch paper such as those containing sodium carboxymethyl cellulose.

Such capsules may be made by freezing honey into balls (for example at a temperature below −0° C., such as below −20° C., for example about −50° C. and the coating with molten wax and then cooling. Plasticizers such as lectin may be added to the wax to improve its resistance to fracture. There are however, difficulties in producing capsule shells that are storage stable and so use of a gel-based product is normally preferred.

Capsules according to the present invention may also be made by any conventional capsule-making method. For example casings can be prepared in a mold the desired amount of honey added and a top then placed upon the product and sealed, for example by heating. Techniques similar to those used for making liqueur chocolates such as those described in U.S. Pat. Nos. 3,962,473 and 3,496,886 may be suitable for producing the desired product.

Other capsule casings or envelope may be made of porous material such as is used for tea bags and in addition to the honey contains an edible swellable material so that when the capsule or envelope is placed in liquid, the liquid penetrates the envelope through the porous casing, causes the swellable material to swell so as to burst the capsule and release the honey.

Capsules according to the present invention may be made by any conventional capsule-making method. For example casings can be prepared in a mold the desired amount of honey added and a top then placed upon the product and sealed, for example by heating. Techniques similar to those used for making liqueur chocolates such as those described in U.S. Pat. Nos. 3,962,473 and 3,496,886 may be suitable for producing the desired product.

If desired a further coating may be applied to the outside of the capsule or other flavor unit, for example a chocolate coating so that addition of the capsules to coffee can produce a café mocha. Alternatively, chocolate may be used as the casing material as in the case of liqueur chocolates.

Flavoring units according to the invention will typically be spherical in shape. Although other shapes such as those having an oval cross-section in the elongated direction.

Products according to the invention may be packaged in any convenient form, including being boxed in one or two layers in a manner similar to that in which chocolates are sold. Alternatively individual flavor units may be individually wrapped, for example by use of a high speed sweet wrapping machine such as those sold by Alibaba Company of Hong Kong or Baker Perkins Company of England. Other packing methods for a gelled product include pouring a liquid mixture of the honey and the material that will form the edible polymer matrix such as gelatin into a “form and seal” plastic cup similar to the containers used to pack portions of jam or a jelly. In one embodiment, the product is packed while still hot and then sealed and cooled to set and solidify the gel.

In use, one simply adds the flavoring unit to the drink to be sweetened and stirs.

### EXAMPLES

### Example 1

A gel containing 1% by weight kappa carrageenan, 19% by weight water and 80% by weight honey was prepared. The kappa carrageenan and water were heated to 185° F. and cooled to 160° F. The honey was heated to 160° F. The two solutions were combined, poured into a mold and allowed to set at ambient temperature. While the resultant gel exhibited syneresis and was tacking to the touch it dissolved in hot water.

The water activity of this gel was determined in order to ascertain that the product will resist microbial activity. The water activity of this sample was 0.6 at 72° F. which makes stable.

### Example 2

Based on the performance of kappa carrgaeenan in Example 1, additional preparations of gels with increased kappa carrageenan were evaluated. At 1.25% and 1.5% by weight kappa carrageenan and 18.75% and 18.5% by weight water respectively, the kappa carrageenan would not hydrate and the gels were not homogeneous, pulpy texture and inferior. Accordingly it is believed that the optimal concentration of the kappa carrageenan is around 1%.

### Example 3

Adding kappa carrageenan directly to honey and heating resulted in poor hydration of the kappa carrageenan and mixing of the components. The gel was gritty. Thus this example illustrates the need for water to hydrate the carrageenan in order to form the gel.

### Example 4

The effect of gelatin in forming a strong gel with the honey was evaluated. A type-A gelatin with a 250 Bloom was evaluated. A solution of 2% by weight gelatin with 18% by weight ambient water was combined. The gelatin was allowed to soften in the water and then heated to 140-150 ° F. to dissolve the gelatin. In a separate mixing vessel honey was heated to 140-150° F. The gelatin water mix comprising 20% and hot honey (comprising 80%) were combined by stirring, poured into a mold and allowed to set at ambient temperature. The resultant gel was firm but stretchy and difficult to handle. The gel dissolved in hot water, but not cold water. The water activity was 0.76 at 72° F.

### Example 5

Based on the performance of type-A gelatin 250 Bloom in Example 4, evaluations were conducted with increased levels of gelatin and the honey. Solutions of 3% and 5% by weight gelatin combined with 17% and 15% by weight water respectively were prepared and combined with 80% by weight honey. The gels were prepared in the same manner as Example 4. The gel with 5% by weight type A 250 Bloom gelatin resulted in a strong, rigid, cuttable gel. The gel dissolved in hot water, but not cold water. The water activity was 0.62 at 72° F. The preparation of this example was the best embodiment of this invention.

Finally, it is understood that various other modifications and/or alterations may be made without departing from the spirit of the present invention.

What I claim is:

1. A flavoring unit comprising from about 1 to about 20 grams of honey is surrounded by a coating or incorporated in a gel or matrix wherein said coating, gel or matrix that will dissolve in, melt in or otherwise be caused to rupture when added to a beverage.

2. A flavoring unit according to feature 1 wherein said unit is a capsule and the casing of said capsule comprises a wax such as a food grade paraffin wax as defined in 21 CFR 172.886, bees wax, rice bran wax, palm wax and soybean wax which melt at the temperature of hot tea or coffee such as between about 100 and about 150° F. preferably between about 120 and about 160° F.

3. A flavoring unit according to claim 1 wherein said unit is a gel.

4. A flavoring unit according to claim 3 comprising from 70 to 90% by weight honey.

5. A flavoring unit according to claim 3 wherein said gel comprises honey and gelatin.

6. A flavoring unit according to claim 4 wherein said gel comprises 75 to 85% by weight honey and from 1 to 5% by weight gelatin.

7. A flavoring unit according to claim 1 which is in the form of a capsule wherein the casing of said capsule comprises water degradable starch paper.

8. A capsule according to claim 1 wherein the casing of said capsule comprises chocolate.

9. A flavoring unit according to claim 1 comprising about 2-15 grams of honey.

10. A flavoring unit according to claim 1 comprising from about 3 to about 7 grams of honey.

11. A flavoring unit according to claim 1 which is individually wrapped.

12. A method of making a flavoring unit according to claim 1 which comprises forming a liquid composition containing honey and a molten edible gel-forming polymer, cooling said mixture to produce a gel and producing forming individual flavoring units containing from about 1 to about 20 grams of honey thereform.

13. A method according to claim 12 wherein said edible gel-forming polymer is gelatin.

14. A method according to claim 12 wherein the liquid composition comprises from about 75% by weight to about 85% by weight honey and from about 1% to about 5% by weight polymer.

15. A method according to claim 14 wherein the polymer is gelatin.

16. A method of making a flavoring unit according to claim 1 which comprises enrobing frozen honey a molten edible polymer fat or wax pouring into molds and cooling said mixture to solidify the edible polymer or wax produce individual flavoring units containing from about 1 to about 20 grams of honey therefrom.
